(19) United States
(12) Patent Application Publication
(10) Pub. No.: US 2012/0217094 A1
(43) Pub. Date: Aug. 30, 2012

(54) PNEUMATIC GREASE GUN

(76) Inventor: Yung-Shing LING, Taichung City (TW)

(21) Appl. No.: 13/035,518

(22) Filed: Feb. 25, 2011

(51) Int. Cl. F16N 5/00; F16N 3/12

(52) U.S. Cl. 184/55.1

(57) ABSTRACT

A pneumatic grease gun includes a handle, a storage container, a coupling tube and a cylinder assembly. The handle has a grip and a bushing. The grip is located at one side of the bushing. The cylinder assembly has two ends connected respectively to the bushing and coupling tube. The coupling tube holds a feeding tube which has one side communicating with the storage container. The feeding tube has a tubular wall coupled with a protrusive O-ring close to the cylinder assembly. The cylinder assembly includes a feeding rod running through the feeding tube and surrounded by the O-ring to prevent grease held in the storage container from flowing back to the cylinder assembly, thus increases the lifespan thereof. The grip is positioned at an adequate location to save user's effort in holding, hence can better meet use requirements.

### FIELD OF THE INVENTION

The present invention relates to a pneumatic grease gun to deliver grease through pressurized air and particularly to grease delivery and handgrip structures of a grease gun.

### BACKGROUND OF THE INVENTION

In heavy duty machines, trucks, trailers or the like, grease usually is injected into the gear boxes or transmission shafts to achieve lubrication and anti-rust functions. During maintenance, the hardened grease has to be removed first, and fresh grease is then replenished to facilitate rotation of gears or transmission shafts to prevent rustiness.

As the structure of the gear box usually is complex and has limited space that makes replenishing the grease manually difficult, a conventional pneumatic grease gun has been developed as shown in FIGS. 1 and 2 that injects grease (not shown in the drawings) from a storage container 3 into a gear box (not shown in the drawings) or a transmission shaft (also not shown in the drawings) through compressed air via a barrel 2, and also removes the hardened grease at the same time to replenish the fresh grease.

In the aforesaid conventional structure, in order to increase pressure to securely replenish the fresh grease into the gear box and remove the hardened grease, dual cylinders 4 and 5 are provided to generate twice amount of pressure to increase thrust to meet the objective of replenishing the grease.

While the aforesaid conventional technique can provide adequate pressure to replenish the grease, friction between the feeding rod 6 and feeding tube 7 tends to produce gaps between them after long-term use, and the grease permeates into the dual cylinders 4 and 5 to cause diminishing of the pressure or even damage. Moreover, the conventional handgrip 8 is installed at the utmost end of the bushing 9, thus users have to bear greater torsion during holding the handgrip. It still leaves a lot to be desired in terms of usability.

### SUMMARY OF THE INVENTION

The primary object of the present invention is to provide a grease delivery structure to prevent grease from permeating into the cylinder to avoid damage.

Another object of the invention is to provide a labor-saving handgrip structure to improve usability.

The present invention provides a pneumatic grease gun which mainly includes a handle, a storage container, a coupling tube and a cylinder assembly. The handle has a grip and a hollow bushing. The grip is located at one side of the bushing. The storage container holds grease. The coupling tube has a feeding tube with one side communicating with the storage container. The cylinder assembly includes a feeding rod and two ends respectively connected to the bushing and coupling tube. The feeding tube has a tubular wall coupled with a protrusive O-ring close to the cylinder assembly. The feeding rod runs through the feeding tube and is surrounded by the O-ring.

By means of the foregoing structure, the O-ring of the invention surrounds the feeding rod to increase sealing, thus can prevent the grease held in the storage container from flowing into the cylinder assembly. As a result, the lifespan increases. Moreover, the grip of the invention is located at one side of the bushing to make gripping easier with less effort, thus can better meet user's requirements.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a conventional pneumatic grease gun.

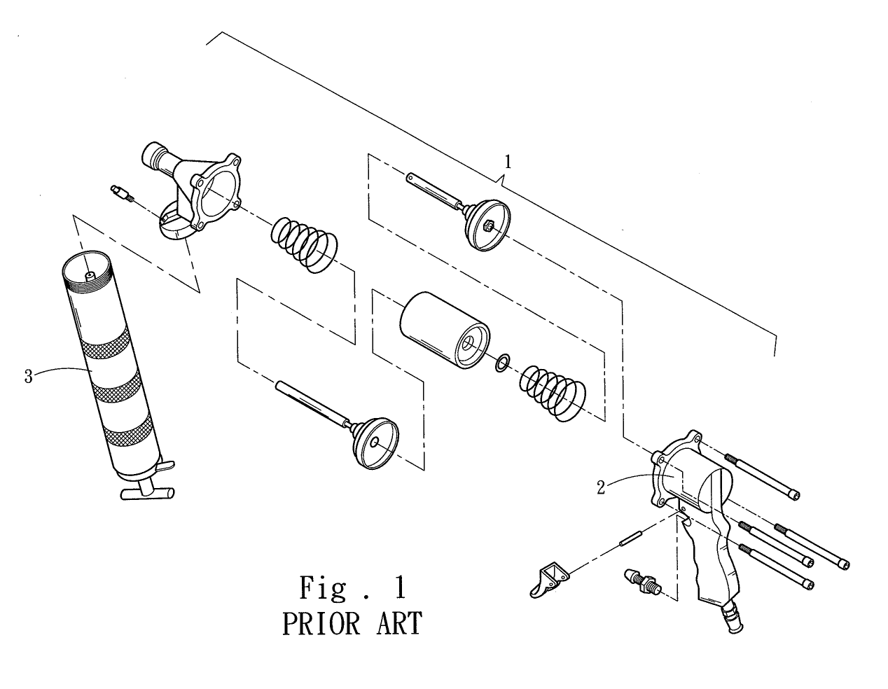

FIG. 2 is a sectional view of a conventional pneumatic grease gun.

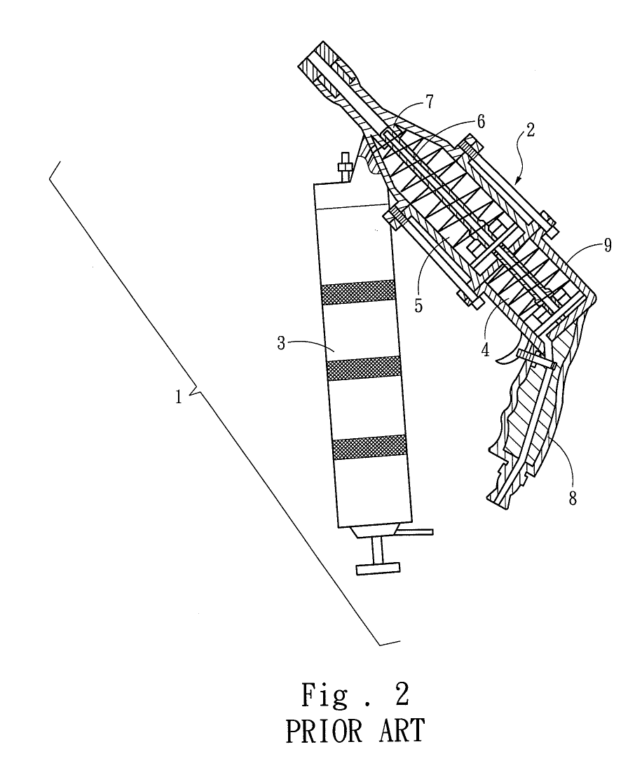

FIG. 3 is an exploded view of an embodiment of the invention.

FIG. 4 is a perspective view of an embodiment of the invention.

FIG. 5 is a partially sectional view of an embodiment of the invention.

FIG. 6 is a schematic view of an embodiment of the invention in a use condition.

### DETAILED DESCRIPTION OF THE PREFERRED EMBODIMENT

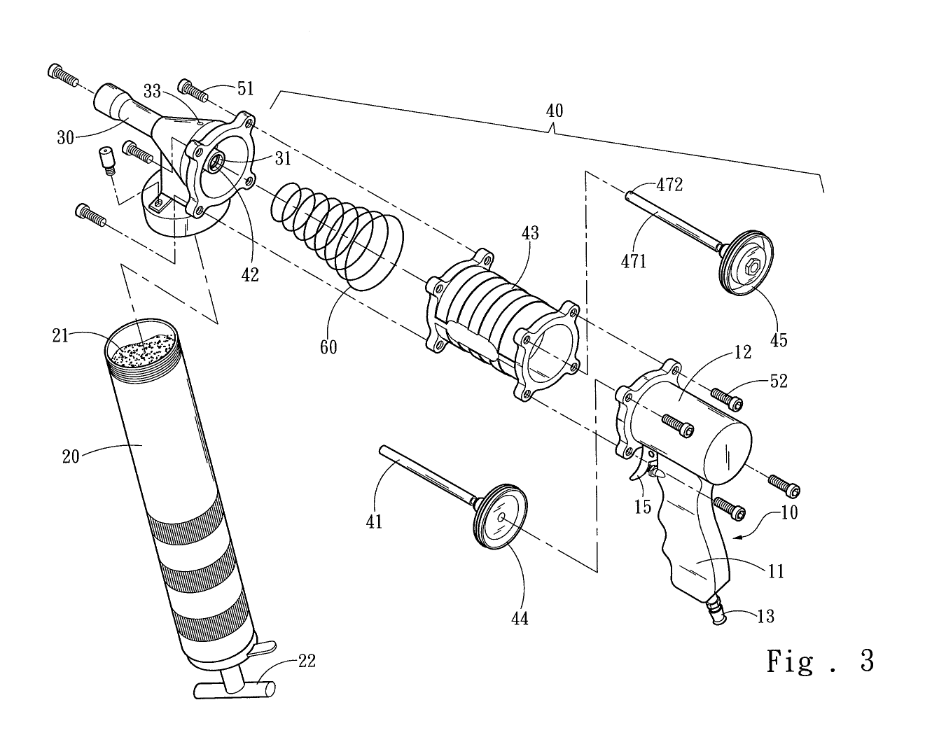

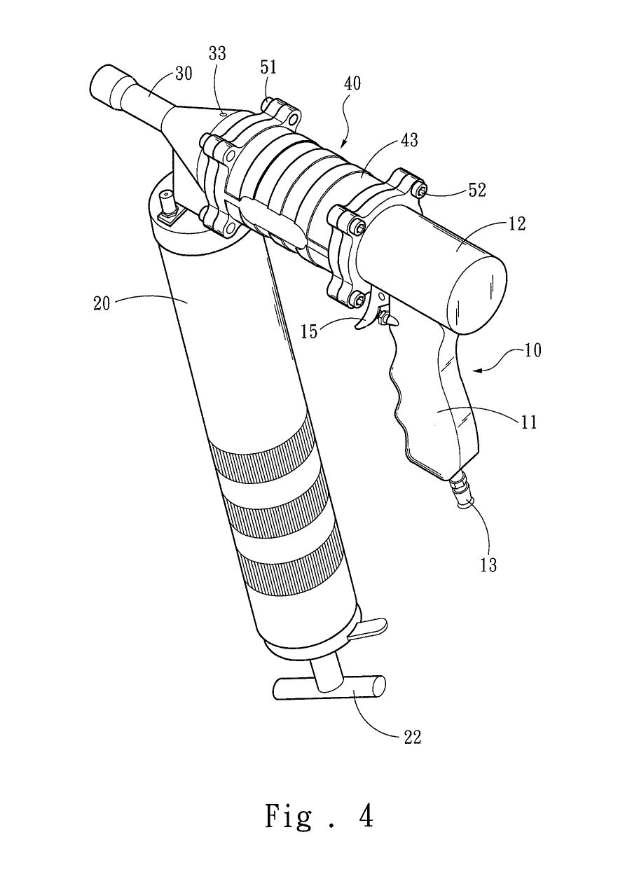

Please refer to FIGS. 3, 4 and 5, the present invention aims to provide a pneumatic grease gun which mainly includes a handle 10, a storage container 20, a coupling tube 30 and a cylinder assembly 40. The handle 10 has a grip 11 and a hollow bushing 12. The grip 11 is located at one side of the bushing 12. The bushing 12 has an air vent 16.

The storage container 20 holds grease 21 and has a push rod 22 at the bottom to squeeze the grease 21. The coupling tube 30 has a feeding tube 31 which has the inner surface formed with a wear-resisting material 311, an air orifice 33 formed thereon, and a conduit 32 at one side communicating with the feeding tube 31 and storage container 20, thus the feeding tube 31 has one side communicating with the storage container 20. The wear-resisting material 311 can be stainless steel with higher hardness to resist friction.

The cylinder assembly 40 includes a feeding rod 41 and two ends respectively connected to the bushing 12 and coupling tube 30. The feeding tube 31 has a tubular wall coupled with a protrusive O-ring 42 close to the cylinder assembly 40. The O-ring 42 can be a rubber ring. The feeding rod 41 runs through the feeding tube 31 and is surrounded by the O-ring 42.

The cylinder assembly 40 includes a cylinder 43, a first piston set 44 and a second piston set 45. The cylinder 43 has two ends respectively connected to the bushing 12 and coupling tube 30. The coupling tube 30 and bushing 12 are fastened to the cylinder 43 through a plurality of bolts 51 and 52. The first and second piston sets 44 and 45 are connected in series and held in the cylinder 43 and bushing 12 to form a first chamber 46, a second chamber 47 and a third chamber 48 in this sequence. The feeding rod 41 is coupled with a spring 60 which is held in the first chamber 46 and butts two ends thereof. The second chamber 47 holds a hollow strut 471 which is connected to the second piston set 45 and butts the first piston set 44. The strut 471 runs through the second piston set 45 and has a front end formed with at least one air port 472 communicating with the second chamber 47 and third chamber 48.

The handle 10 has a distal end coupled with an air intake nozzle 13, a duct 14 located inside and connected to the third chamber 48 and air intake nozzle 13, and a pressing switch 15 to control air intake.

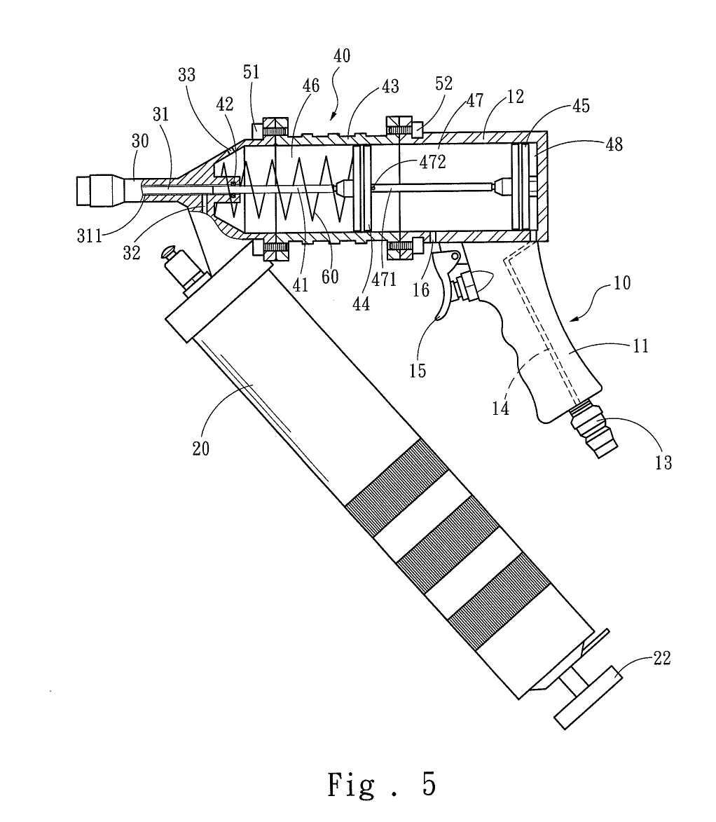

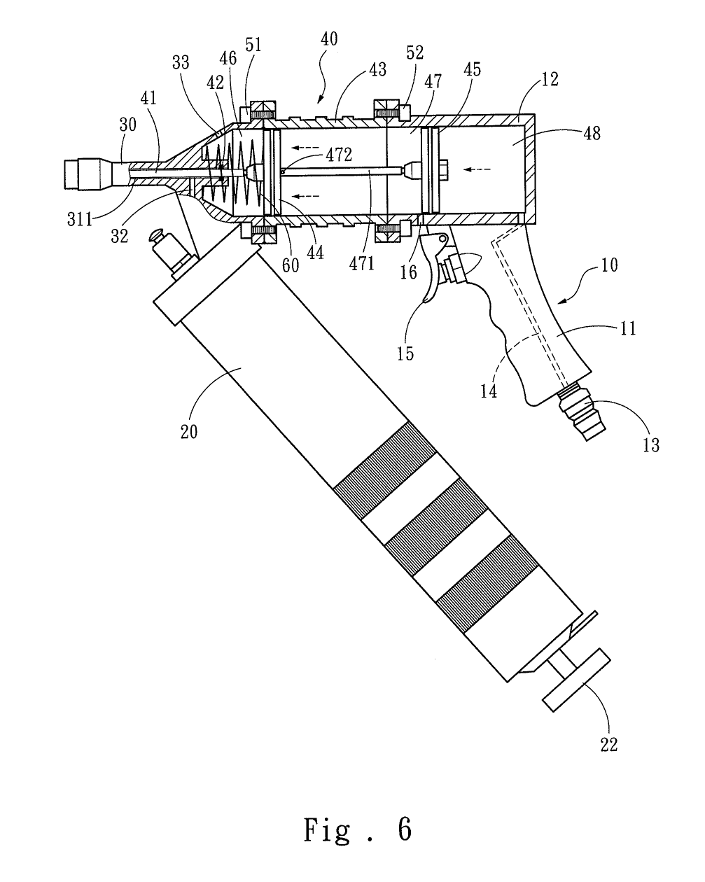

Also referring to FIGS. 5 and 6, when changing the grease 21 is required, first, push the push rod 22 to squeeze the grease 21 into the feeding tube 31; then press the pressing switch 15 to allow high pressure air to enter the third chamber 48 and flow into the second chamber 47 via the hollow strut 471, so that the second piston set 45 and first piston set 44 are moved at the same time to generate double pressure to push the feeding rod 41 to squeeze the grease 21, thereby replenishing of the grease 21 can be accomplished. Through the returning force of the spring 60 and ventilation of the air vent 16 and air orifice 33, the pneumatic grease gun can return to its original position.

As a conclusion, the feeding rod 41 of the invention is surrounded by the O-ring 42 to produce improved sealing to prevent the grease 21 held in the storage container 20 from entering the cylinder assembly 40, thus can avoid diminishing of pressure or cause damage to the cylinder assembly 40. Lifespan can increase. Moreover, the grip 11 of the invention is located at one side of the bushing 12 which is close to the gravity center, hence is reduced torsion on user's wrist. Users can grip easier with less effort, thus usability improves.

What is claimed is:

1. A pneumatic grease gun, comprising:
a handle including a grip and a hollow bushing, the grip being located at one side of the bushing;
a storage containing to hold grease;
a coupling tube including a feeding tube which includes one side communicating with the storage container; and
a cylinder assembly which includes a feeding rod and two ends coupled respectively with the bushing and the coupling tube, the feeding tube including a tubular wall coupled with a protrusive O-ring close to the cylinder assembly, the feeding rod running through the feeding tube and being surrounded by the O-ring.

2. The pneumatic grease gun of claim 1, wherein the storage container includes a push rod at a bottom end to squeeze the grease.

3. The pneumatic grease gun of claim 1, wherein the feeding tube includes a conduit at one side communicating with the feeding tube and the storage container.

4. The pneumatic grease gun of claim 1, wherein the cylinder assembly includes a cylinder, a first piston set and a second piston set, the cylinder including two ends respectively coupled with the bushing and the coupling tube, the first piston set and the second piston set being connected in series and held in the cylinder and the bushing to form a first chamber, a second chamber and a third chamber in this sequence, the feeding rod being coupled with a spring which is held in the first chamber and butts two ends thereof, the second chamber holding a hollow strut which is connected to the second piston set and butts the first piston set, the strut running through the second piston set and including at least one air port at a front end to communicate with the second chamber and the third chamber.

5. The pneumatic grease gun of claim 4, wherein the handle includes a distal end coupled with an air intake nozzle, a duct held inside and connected to the third chamber and the air intake nozzle, and a pressing switch to control air intake.

6. The pneumatic grease gun of claim 4, wherein the coupling tube and the bushing are fastened to the cylinder through a plurality of bolts.

7. The pneumatic grease gun of claim 1, wherein the O-ring is a rubber ring.

8. The pneumatic grease gun of claim 1, wherein the feeding tube includes an inner surface formed with a wear-resisting material.

9. The pneumatic grease gun of claim 8, wherein the wear-resisting material is stainless steel.
